(19) United States
(12) Patent Application Publication
(10) Pub. No.: US 2005/0078407 A1
(43) Pub. Date: Apr. 14, 2005

(54) Base plate design for reducing deflection of suspension assembly by swaging

(75) Inventors: Ittipon Diewanit, Nontaburi (TH); Khampon Sittipongpanich, Bangkok (TH); Tossapon Chettaisong, Pathumthani (TH); Visit Thaveeprungsriporn, Bangkok (TH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: KR Precision Public Company Limited, Ayutthaya (TH)

(21) Appl. No.: 10/944,439

(22) Filed: Sep. 17, 2004

Related U.S. Application Data
(60) Provisional application No. 60/504,376, filed on Sep. 18, 2003.

(51) Int. Cl. G11B 17/00

(52) U.S. Cl. 360/97.01

(57) ABSTRACT

Techniques for coupling a suspension assembly to an actuator arm is provided. The base plate includes a metal member and a swaging boss formed by the metal member. At least one slot disposed in the swaging boss to distribute stress and deformation of the swaging boss during a swaging process. The base plate couples to the actuator arm via the swaging boss. A method for coupling a base plate to an actuator arm includes forcing first and second swage balls through a swage hole of the base plate. A diameter of the first swage ball is greater than the diameter of the swage hole, and a diameter of the second swage ball is greater than the diameter of the first swage ball. The swage hole is shaped by a swaging boss, which swaging boss includes at least one slot.

### CROSS-REFERENCES TO RELATED APPLICATIONS

This application claims priority from U.S. provisional patent application No. 60/504,376, filed Sep. 18, 2003, entitled “Base plate Design for Minimizing Deflection of Suspension Assembly by Swaging,” which disclosure is incorporated herein by reference.

### BACKGROUND OF THE INVENTION

The present invention relates to disk drives. More particularly, the invention provides a head-gimbal assembly which is attached to an actuator arm by a swaging process. Merely by way of example, the invention is applied to hard disk apparatus, but it would be recognized that the invention has a much broader range of applicability.

A hard disc drive (HDD) unit generally uses a spinning storage medium (e.g., a disk or platter) to store data. A read-write head is positioned in close proximity to the spinning storage medium by a head stack assembly (HSA). Mounted on the HSA, a suspension assembly commonly includes a base plate, a load beam, and a flexure trace gimbal to which a slider is mounted. The slider supports the read-write head element. The load beam is generally composed of an actuator mounting section, a spring region and a rigid region. The spring region gives the suspension a spring force or preload counteracting the aerodynamic lift force created by the spinning medium during reading or writing. A gimbal is mounted at the distal end of the load beam and supports the slider allowing the head to have pitch and roll movement in order to follow the irregularities of the disk surface.

Demand generally requires increased HDD storage capacity, which generally compels higher track densities. Data tracks often become narrower and the spacing between data tracks on the storage medium decreases. An obstacle associated with increased track densities is accurate positioning of the read/write head over the desired track due to turbulent air streams generated by the spinning storage medium. It is therefore important to produce head stack assemblies with stable and consistent parameters such as gram force, z-height, and static attitude. Nevertheless, mass production generally leads to a statistical distribution of parameters as parameters deteriorate with each subsequent processing step. In fact, some HDD components are often damaged during assembly using conventional techniques.

One damaging process is a swaging process which mounts the HGA on an actuator arm. The swaging process uses a series of steel balls having diameters slightly larger than a swage boss hole in a swage boss. For example, referring to FIG. 1, conventional base plate 100 includes a swage boss hole 104 and a swage boss 102. During the swaging process, the series of steel balls is accelerated through the swage boss hole 104. The swage boss 102 deforms plastically to form a press fit with the actuator arm (i.e., boss 102 expands, embeds, and locks with the actuator arm). This adversely affects uniformity of flying height of the head above the spinning storage medium making accurate positioning difficult.

U.S. Pat. No. 6,399,179, entitled “Base Plate for Suspension Assembly in Hard Disk Drive with Stress Isolation,” to Hanrahan et al., and assigned to Intri-plex Technologies, Inc. and Western Digital (Fremont), Inc., attempts to minimize base plate distortion by disclosing stress isolation features, a series of holes in the flange surrounding the clamping region. These features, however, often result in weakening the structural aspect of the base plate, particularly lowering the dynamic performance of a suspension assembly. These and other limitations may be further described throughout the present specification and more particularly below.

As can be seen from the above, improved techniques for mounting a suspension assembly to an actuator arm are needed.

### BRIEF SUMMARY OF THE INVENTION

The present invention relates to disk drives. More particularly, the invention provides a head-gimbal assembly which is attached to an actuator arm by a swaging process. Merely by way of example, the present invention is implemented using a base plate requiring swaging or press-fitting technique to mount onto actuator arm, but it would be recognized that the invention has a much broader range of applicability in other types of base plate or swaging members.

The swaging process causes the actuator arm and the base plate to permanently deform resulting in an increase in variations by two to three times its original z-height and gram load. FIG. 2 shows measured deflection results after swaging for a conventional base plate. We have realized, through finite element analysis, that the magnitude and distribution of stress and deformation generated by swaging create significant deflection on the base plate through materials being drawn towards the swage boss hole. The magnitude of the stress often cannot be reduced as a retention force of the resulting press fit is needed to ensure reliability of the connection of the base plate to an actuator arm. However, the distribution of stress can be manipulated to minimize the deflection of the base plate according to techniques described herein.

In a specific embodiment, the suspension assembly includes a read/write head, a flexure, and a suspension arm (load beam). The suspension assembly at a distal end includes a flexure supporting the read/write head, while the proximal portion of the assembly includes a hole having an attached swaging member extending through it. The swaging member includes a base plate and a swaging boss. On the swaging member, a circular hole is formed through a top surface of the base plate by deep drawing. To minimize distortion of the base plate during swaging, a slot or slots are formed on the top surface of the swaging boss. The slot(s) can be formed or cut in any direction with respect to the suspension arm longitudinal axis depending on the base plate design and actuator arm assembly configuration. These slots better distribute stress during swaging without increasing the swaging force, and thus reduces the permanent deformation on the actuator arm and allows rework of the assembly for troubleshooting and repairing purposes.

In another embodiment, a base plate for a hard disk drive apparatus is provided. The base plate includes a metal member and a swaging boss. At least one slot is disposed in the swaging boss. The base plate couples to an actuator arm of the hard disk drive apparatus via the swaging boss.

In yet another embodiment, a method for coupling a base plate to an actuator arm is provided. The method includes forcing first and second swage balls through a swage hole of the base plate. A diameter of the first swage ball is greater than the diameter of the swage hole, and a diameter of the second swage ball is greater than the diameter of the first swage ball. The swage hole is shaped by a swaging boss, which swaging boss includes at least one slot.

Many benefits are achieved by way of the present invention over conventional techniques. For example, the present technique provides an easy to use swaging process that relies upon conventional technology. Additionally, the present invention uses a novel technique to reduce deformation of a base plate, thereby reducing variations in z-height and gram load. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 shows a conventional base plate;

FIG. 2 shows measured deflection results after swaging for a conventional base plate;

FIG. 3 shows a simplified hard disk drive apparatus according to an embodiment of the present invention;

FIG. 4 illustrates a simplified single slot base plate according to an embodiment of the present invention;

FIG. 5 illustrates a simplified single slot base plate according to another embodiment of the present invention;

FIG. 6 illustrates a simplified two slot base plate according to an embodiment of the present invention;

FIG. 7 illustrates a simplified two slot base plate according to another embodiment of the present invention;

FIG. 8 illustrates a simplified three slot base plate according to an embodiment of the present invention;

FIG. 9 illustrates a simplified four slot base plate according to an embodiment of the present invention;

FIG. 10 shows simulated deflection results after swaging for an exemplary slotted base plate according to an embodiment of the present invention as compared to conventional base plate.

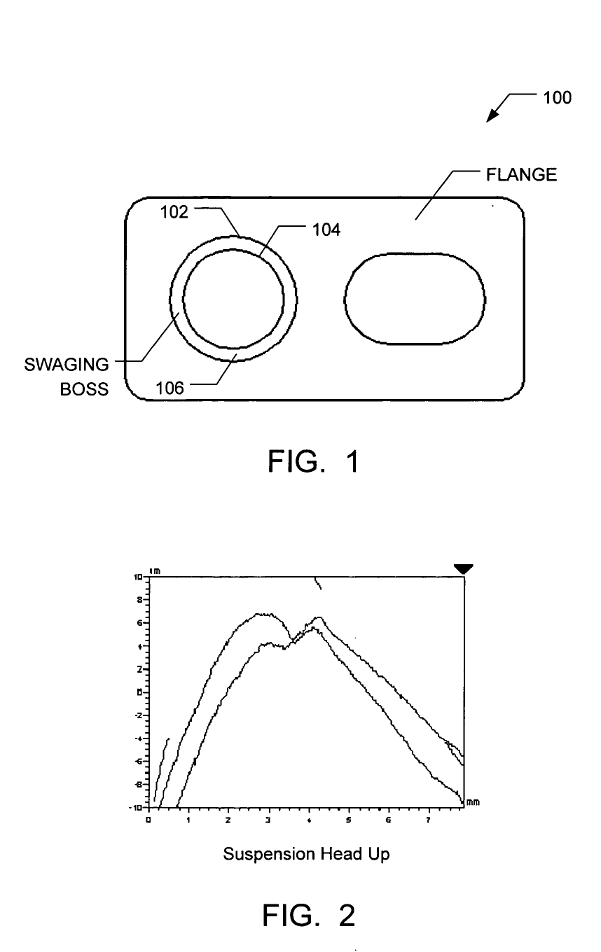

### DETAILED DESCRIPTION OF THE INVENTION

Techniques for manufacturing a disk drive apparatus are provided. More particularly, the present invention provides a method and apparatus for coupling a suspension assembly to an actuator arm.

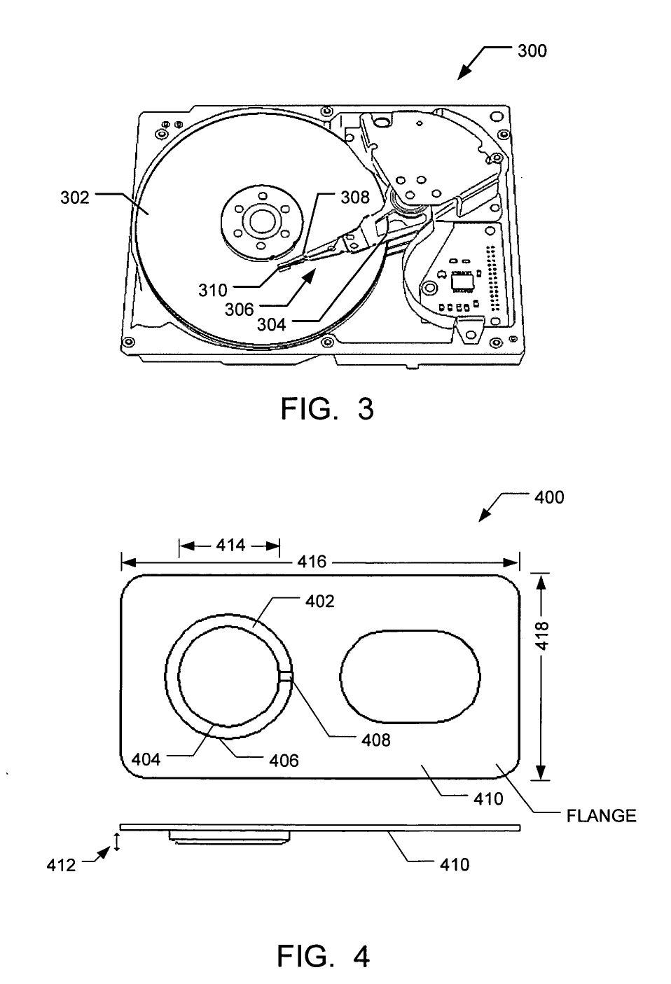

FIG. 3 is a simplified diagram of a disk drive apparatus 300 according to an embodiment of the present invention. This diagram is merely an example, which should not unduly limit the scope of the claims herein. One of ordinary skill in the art would recognize other variations, modifications, and alternatives. Apparatus 300 includes at least one disk 302 (e.g., one, two, three, or more disks), at least one actuator arm 304 (e.g., one, two, three, or more actuator arms), and at least one suspension assembly 306 (e.g., one, two, three, or more suspension assemblies). Each suspension assembly is composed of a load beam 308, head gimbal assembly (HGA) 310, and base plate 312 (not shown). Base plate 312 connects the suspension assembly to an actuator arm 304. Actuator arm 304 is generally aluminum. This diagram, as well as other diagrams provided herein, is merely an example, which should not unduly limit the scope of the claims herein. One of ordinary skill in the art would recognize many other variations, modifications, and alternatives.

Disk 302, commonly called a platter, rotates about a fixed axis (or spindle) from about 5,000 rpm up to about 15,000 rpm depending upon the embodiment. Disk 302 stores information and thus often includes a magnetic medium such as a ferromagnetic material. But, it can also include optical materials, common coated on surfaces of the disk, which become active regions for storing digital bit information.

The aggregate storage capacity of disk 302 will vary with track density and disk diameter. Disk 302 stores information in tracks which can be in a range of about 50,000 tracks per inch (TPI) to about 200,000 TPI, or more. The diameter of disk 302 can be 5.12 inches (e.g., for a 5.25 inch drive), 3.74 inches (e.g., for a 3.5 inch drive), or less than 2.5 inches, or even less than 1.8 inches or 1.0 inch.

Suspension assembly 306, which overlies (or underlies) a surface of disk 302, operates and controls a slider coupled to a read/write head (not shown). Flexure trace gimbal assembly 310 is attached to suspension assembly 306 which is in turn is connected to actuator arm 103. Actuator arm 304 is connected to a voice coil motor or VCM, which moves suspension assembly 306 about a pivot point in an annular manner. The VCM can move at frequencies from DC up to about 1 kHz. Preferably, for higher track density, e.g., 200,000 TPI, the control bandwidth can approach 5 kHz, but can also be greater in certain embodiments.

FIG. 4 illustrates an exemplary single slot base plate 400 according to an embodiment of the present invention. This diagram is merely an example, which should not unduly limit the scope of the claims herein. One of ordinary skill in the art would recognize other variations, modifications, and alternatives. Base plate 400 is a metal support member. In particular, base plate 400 can be comprised, or essentially comprised, of stainless steel. In a specific embodiment, base plate 400 is 300 series stainless steel. The thickness of base plate 400 can be in a range of about 0.0049 inches to about 0.008 inches. In addition, base plate 400 defines a width 418, which can be about 0.1575 inches to about 0.252 inches, and a length 416, which can be about 0.2 inches to about 0.3378 inches.

Base plate 400 includes a swaging boss 402 that is generally perpendicular to a surface 410. Thickness of swaging boss 402 can be defined between swage hole 404 (inner diameter) and a swage wall 406 (outer diameter). In specific embodiments, thickness of swaging boss 406 is in the range of about 0.0136 inches to about 0.0156 inches. Boss height 412 of swaging boss 406 is defined from a proximal end at surface 410 to a distal end. Boss height 412 is in the range of about 0.01 inches to about 0.013 inches.

Swaging boss 402 may have any arbitrary profile (interior or exterior) along boss height 412. For example, the interior profile of swaging boss 402 may taper toward the center of swage hole 404. The diameter 414 of swaging hole 404 can be in a range of about 0.048 inches to about 0.078 inches. In this specific embodiment shown in FIG. 4, swaging hole 404 is circular. In alternative embodiments, swaging hole 404 may take other arbitrary shapes (i.e., a non-round swage boss feature). A series of metal swaging balls may be forced through swaging hole 404 to couple base plate 400 to an actuator arm. A diameter of each of the swaging balls can be larger than the swaging hole 404, and generally during swaging smaller swaging balls are forced through swaging hole 404 before larger swaging balls. For example, in a series of three swaging balls, the diameters can be about 0.079 inches, about 0.081 inches, and about 0.082 inches, respectively.

A slot 408 is disposed along a portion of boss height 412. Preferably, slot 408 extends at least in a range of about 50% to about 100% of boss height 312. Slot 408 also extends the entire thickness of swaging boss 402. In alternative embodiments, slot 408 may extend a portion of such thickness, for example, in a range of about 50% to about 100% of swaging boss 402 thickness. It should be noted that slot 408 is rectangular, but slots according to another embodiment of the present invention can be any arbitrary shape (such as a trapezoid and others). Slots can be produced by mechanical stamping, mechanical milling, ion milling, laser ablating, and/or chemical etching portions of a swaging boss.

In this particular embodiment, the distal portion of base plate 400 includes a flange. The flange provides sufficient support to connect base plate 400 to a hinge member(s) or a load beam. The flange consists of two extents formed around a hole in the distal portion of base plate 400. The two extents meet at the distal end of base plate 400. However, in alternative embodiments, the two extents can remain separated at the distal end.

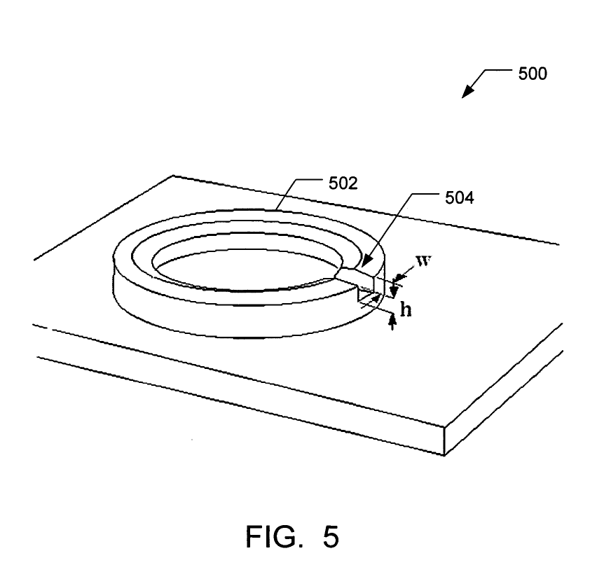

FIG. 5 illustrates a simplified single slot base plate 500 according to another embodiment of the present invention. This diagram is merely an example, which should not unduly limit the scope of the claims herein. One of ordinary skill in the art would recognize other variations, modifications, and alternatives. Base plate 500 is substantially a flat metal beam with a swaging boss 502. Swaging boss 502 includes a slot 504 extending longitudinally through the thickness of swaging boss 502 and vertically through a portion of the height of swaging boss 502. In this example, the distal portion of base plate 500 does not include a hole. One of ordinary skill in the art would recognize many other variations, modifications, and alternatives to base plate 500 in light of the disclosures herein.

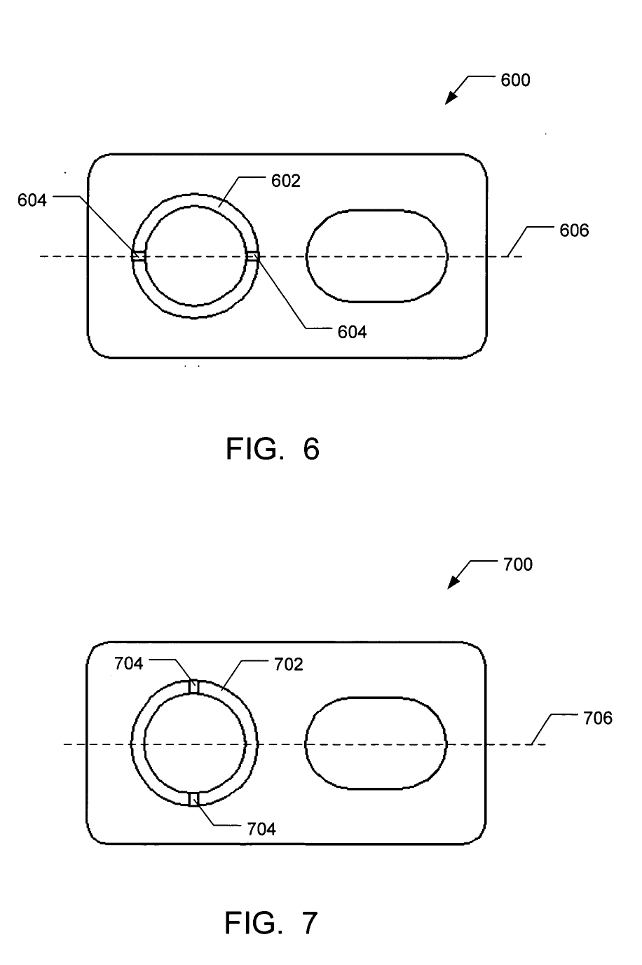

FIG. 6 illustrates a simplified two slot base plate 600 according to an embodiment of the present invention. This diagram is merely an example, which should not unduly limit the scope of the claims herein. One of ordinary skill in the art would recognize other variations, modifications, and alternatives. Base plate 600 includes two slots 604 in swaging boss 602. Slots 604 are disposed on a longitudinal axis 606 of base plate 600 and on opposite portions of swaging boss 602 (e.g., separated by 180 degrees on swaging boss 602). Alternatively, in FIG. 7, slots 704 in swaging boss 702 are disposed perpendicular to a longitudinal axis 706 of base plate 700. In other embodiments of the present invention, slots need not be separated by 180 degrees on a swaging boss. For example, a two slot base plate could include slots separated by less 180 degrees (such as by about 135 degrees, about 90 degrees, about 45 degrees, or about 10 degrees, or less).

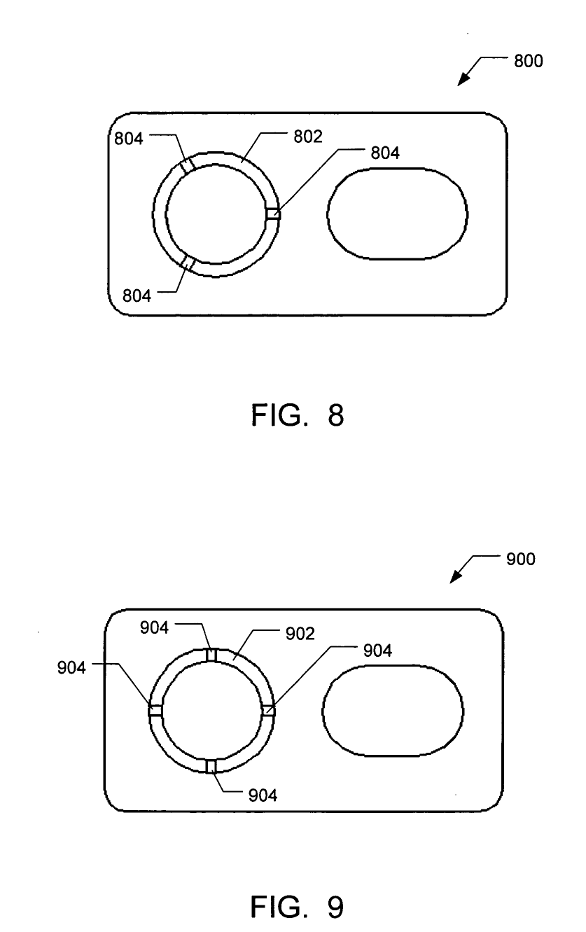

FIGS. 8-9 illustrate a simplified three slot base plate 800 and a simplified four slot base plate 900, respectively, according to embodiments of the present invention. These diagrams are merely examples, which should not unduly limit the scope of the claims herein. One of ordinary skill in the art would recognize other variations, modifications, and alternatives. In FIG. 8, slots 804 in swaging boss 802 are disposed equidistantly from each other (i.e., 60 degrees between each slot 804). Similarly, in FIG. 9, four slots 904 in swaging boss 902 are also disposed equidistantly (i.e., 45 degrees between each slot 904). It should be noted that slots need not be spaced in such a uniform manner. For example, slots can be disposed to bias a specified portion or segment of a swaging boss to tailor a distribution of stress and deformation for a specific application. As shown by FIGS. 6-9, a swaging boss can include a plurality of slots. In fact, a swaging boss can include more than four slots, such as five, six, seven, or more.

Simulated Deformation Results

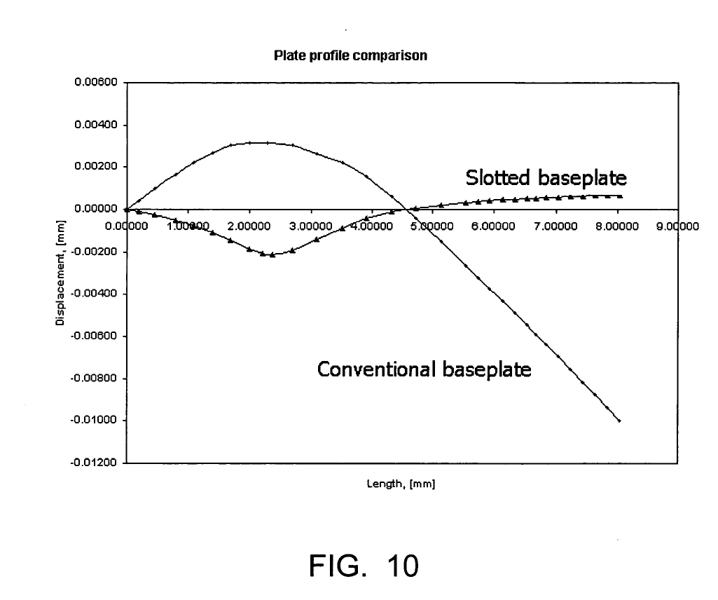

To establish the principle and operation of the present invention, we performed finite element simulations using MSC.Marc® by MSC.Software Corporation. These simulations were merely examples and should not unduly limit the scope of the inventions defined by the claims herein. One of ordinary skill in the art would recognize many other variations, modifications, and alternatives. FIG. 10 demonstrates improvements in base plate deflection by a slotted base plate according a specific embodiment of the present invention over a conventional base plate. The magnitude of displacement found in the slotted base plate is generally about one-half to about one-tenth of the displacement in a conventional base plate.

One of ordinary skill in the art would recognize many other variations, modifications, and alternatives. The above examples are merely illustrations, which should not unduly limit the scope of the claims herein. It is also understood that the examples and embodiments described herein are for illustrative purposes only and that various modifications or changes in light thereof will be suggested to persons skilled in the art and are to be included within the spirit and purview of this application and scope of the appended claims.

1. A base plate for a hard disk drive apparatus having an actuator arm, the base plate comprising:
a metal member;
a swaging boss formed by the metal member; and
at least one slot disposed in the swaging boss,
wherein the base plate couples to the actuator arm via the swaging boss.

2. The base plate of claim 1 wherein the metal member comprises stainless steel.

3. The base plate of claim 1 wherein the metal member essentially comprises stainless steel.

4. The base plate of claim 1 wherein the at least one slot is a plurality of slots.

5. The base plate of claim 4 wherein the plurality of slots are equidistantly disposed about a perimeter of swaging boss.

6. The base plate of claim 1 wherein the at least one slot is shaped as a rectangular trench.

7. The base plate of claim 1 wherein a depth of at least one slot is in a range of about 125 microns to about 330 microns.

8. The base plate of claim 1 wherein a width of at least one slot is in a range of about 100 microns to about 300 microns.

9. The base plate of claim 1 wherein the swaging boss includes a circular swage hole.

10. The base plate of claim 1 wherein the at least one slot is formed by at least one of mechanical milling, ion milling, laser ablating, and chemical etching a portion of the swaging boss.

11. A plate comprising:
a metal member;
a circular swaging boss formed by the metal member; and
a plurality of rectangular slots disposed in the swaging boss.

12. A method for coupling a base plate to an actuator arm, the method comprising:
pushing a first swage ball through a swage hole of the base plate, the swage hole formed by a swaging boss; and
pushing a second swage ball through the swage hole of the base plate,
wherein a diameter of the first swage ball is greater than the diameter of the swage hole,
a diameter of the second swage ball is greater than the diameter of the first swage ball, and
at least one slot is disposed in the swaging boss.

13. The method of claim 12 further comprising pushing a third swage ball through the swage hole of the base plate, wherein a diameter of the third swage ball is greater than the diameter of the second swage ball.

14. The method of claim 12 wherein the at least one slot is at least two slots.

15. The method of claim 12 wherein the base plate comprises stainless steel.

16. The method of claim 12 wherein the pushing accelerates the first and second swage balls through the swage hole.

17. The method of claim 12 wherein the pushing the first swage ball through a swage hole plastically deforms the swage boss.

18. The method of claim 12 further comprising forming the at least one slot by at least one of mechanical milling, ion milling, laser ablating, and chemical etching a portion of the swaging boss.
